(19) United States
(12) Patent Application Publication
(10) Pub. No.: US 2026/0260205 A1
(43) Pub. Date: Sep. 3, 2026

(54) DELIVERY MANAGEMENT METHOD FOR A CONSUMER PRODUCT SUBSCRIPTION

(71) Applicant: The Gillette Company LLC, Boston, MA (US)

(72) Inventors: Kyra Cecelia Post, Cambridge, MA (US); Brian Andrew Rodkey, Ashland, MA (US)

(21) Appl. No.: 19/549,727

(22) Filed: Feb. 25, 2026

Related U.S. Application Data
(60) Provisional application No. 63/765,060, filed on Feb. 28, 2025.

(51) Int. Cl. G06Q 10/083; G06Q 20/10

(52) U.S. Cl. CPC G06Q 10/0843; G06Q 20/102

(57) ABSTRACT

A delivery management method is provided. An input is received indicating a consumer product for a subscription. An output is provided indicating the consumer product subscription. Information is communicated to a dispatching entity to dispatch the first shipment. A request is received for a second shipment. A time period between the first shipment and the received second shipment request is compared with a predetermined time period or a time of the received request is compared with a subscription time period. If the time period is greater than or equal to the predetermined time period, information is communicated to dispatch the second shipment. If the time period is less than the predetermined time period or if the time of the received request is after expiration of the subscription time period, information is communicated to reject the second shipment.

### FIELD OF THE INVENTION

The present disclosure relates generally to delivery management methods and more specifically to a delivery management method for a consumer product subscription.

### BACKGROUND OF THE INVENTION

When consumers use consumer products, such as razor cartridges, their rate of use may depend on how many razor cartridges they have left. This is due to many consumers wanting to avoid having to pay for additional razor cartridges. Thus, many consumers may keep using a razor cartridge beyond its proper use cycle, which may lead to bad shaving results.

Although subscriptions are available for consumer products, such as razor cartridges, such subscriptions typically ship the consumer a certain number of razor cartridges at regular time intervals, irrespective of whether the consumer needs additional razor cartridges. Thus, these conventional subscriptions may result in the consumer paying for additional razor cartridges that are not needed at the time of shipment. Conversely, if the consumer runs out of razor cartridges prior to the regular time interval of the next shipment, they may continue to use razor cartridges beyond their proper use cycle, resulting in a bad shaving experience.

Additionally, conventional subscriptions for consumer products routinely require the consumer to provide a payment for each shipment of consumer products at the regular time intervals. In order to avoid having to provide these subsequent payments, many consumers cancel such subscriptions or delay the next shipment.

The discussion of shortcomings and needs existing in the field prior to the present disclosure is in no way an admission that such shortcomings and needs were recognized by those skilled in the art prior to the present disclosure.

### SUMMARY OF THE INVENTION

Various embodiments solve the above-mentioned problems and provide methods and devices useful for a delivery management method for a consumer product subscription. This delivery management method addresses the shortcomings of conventional consumer product subscriptions by only shipping consumer products to the consumer when they are needed. Thus, the improved delivery management method advantageously assists the consumer with having a more consistent experience, such as a more consistent shave with razor cartridges. Additionally, the improved delivery management method only requires one upfront payment from the consumer at the beginning of a subscription time period. Thus, the consumers advantageously do not need to provide payment at the time of each shipment during the subscription time period, thereby avoiding the discomfort of having to provide multiple payments.

In a first set of aspects, a delivery management method is provided. The method may include a step of providing a user interface for communicating a shaving cartridge subscription. The method may also include a step of receiving, from the user interface, an input indicating a shaving cartridge for the shaving cartridge subscription. The method may also include a step of outputting, on the user interface, an output indicating the shaving cartridge for the shaving cartridge subscription, a cost of the shaving cartridge subscription and a quantity of the shaving cartridges in a first shipment of the shaving cartridge subscription. The method may also include a step of communicating information related to the first shipment of the shaving cartridge subscription to a dispatching entity to dispatch the first shipment of the shaving cartridge subscription. The method may also include a step of receiving a request for a second shipment of the shaving cartridges in the shaving cartridge subscription. The method may also include a step of comparing, with a processor, a time period between the dispatch of the first shipment of the shaving cartridge subscription and the received request for the second shipment of the shaving cartridge subscription with a predetermined time period. If the time period is greater than or equal to the predetermined time period, the method may include a step of communicating information to the dispatching entity to dispatch the second shipment of the shaving cartridge subscription. If the time period is less than the predetermined time period, the method may include a step of communicating information to indicate a rejection of the request for the second shipment of the shaving cartridge subscription.

In second set of aspects, a computer-implemented process is provided for efficiently delivering orders of products to a consumer. The process may include a step of providing a user interface for communicating a consumer product subscription. The process may also include a step of receiving, from the user interface, an input indicating a consumer product for the consumer product subscription. The process may also include a step of outputting, on the user interface, an output indicating the consumer product for the consumer product subscription, a cost of the consumer product subscription and a quantity of the consumer products in a first shipment of the consumer product subscription. The process may also include a step of communicating information related to the first shipment of the consumer product subscription to a dispatching entity to dispatch the first shipment of the consumer product subscription. The process may also include a step of receiving a request for a second shipment of the consumer products in the consumer product subscription. The process may also include a step of comparing, with a processor, a time period between the dispatch of the first shipment of the consumer product subscription and the received request for the second shipment of the consumer product subscription with a predetermined time period. If the time period is greater than or equal to the predetermined time period, the method may include a step of communicating information to the dispatching entity to dispatch the second shipment of the consumer product subscription. If the time period is less than the predetermined time period, the method may include a step of communicating information to indicate a rejection of the request for the second shipment of the consumer product subscription.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which illustrate examples according to various embodiments.

FIG. 1 is a block diagram that illustrates an example of a system for performing a delivery management method, according to an aspect of the disclosure;

FIG. 2 is a schematic diagram that illustrates an example of a mobile device that may be used in the system of FIG. 1, according to an aspect of the disclosure;

FIGS. 3A and 3B are perspective views that illustrate an example of a razor cartridge and shaving razor handle that may be delivered in the delivery management method, according to an aspect of the disclosure;

FIGS. 3C and 3D are schematic views that illustrate an example of packages of razor cartridges dispatched in a first and second shipment of the delivery management method, according to an aspect of the disclosure;

FIGS. 4A through 4D are front views that illustrate an example of various outputs on the user interface of the system of FIG. 1 during the delivery management method, according to an aspect of the disclosure;

FIGS. 5A through 5E are timelines that illustrate an example of various sequences of the steps of the delivery management method, according to an aspect of the disclosure;

FIG. 6A is a flowchart that illustrates an example of various steps of the delivery management method, according to an aspect of the disclosure;

FIG. 6B is a flowchart that illustrates an example of various steps of a method for calibrating the consumer product subscription of the delivery management method, according to an aspect of the disclosure;

FIG. 7 is a block diagram that illustrates a computer system upon which an aspect of the disclosure may be implemented;

FIG. 8 is a block diagram that illustrates a chip set upon which an aspect of the disclosure may be implemented; and

FIG. 9 is a block diagram that illustrates a mobile terminal upon which an aspect of the disclosure may be implemented.

It should be understood that the various embodiments are not limited to the examples illustrated in the figures.

### DETAILED DESCRIPTION OF THE INVENTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Consumer product” includes, but is not limited to one or more of toothbrushes, shaving razor cartridges, toothpaste, hair care products, household cleaning products, feminine hygiene products, diapers, baby care products, toilet paper, paper towels, insect traps and repellants, perfume, dental care products, body cleansing and moisturizing products.

“Consumer product subscription” refers to a subscription having a subscription time period over which a consumer may receive one or more shipments of consumer products, where a first shipment of the consumer products may be automatically provided to the consumer and subsequent shipments of the consumer products may be provide in response to a request from the consumer, if certain criteria are met.

“Predetermined time period” refers to a minimum time period between a most recent shipment of consumer products and a next request for a subsequent shipment of consumer products in a consumer product subscription, in order for the subsequent shipment to be authorized.

“Time period” refers to a duration of time between a most recent shipment of consumer products in a subscription and a next request for a subsequent shipment of consumer products.

### System Overview

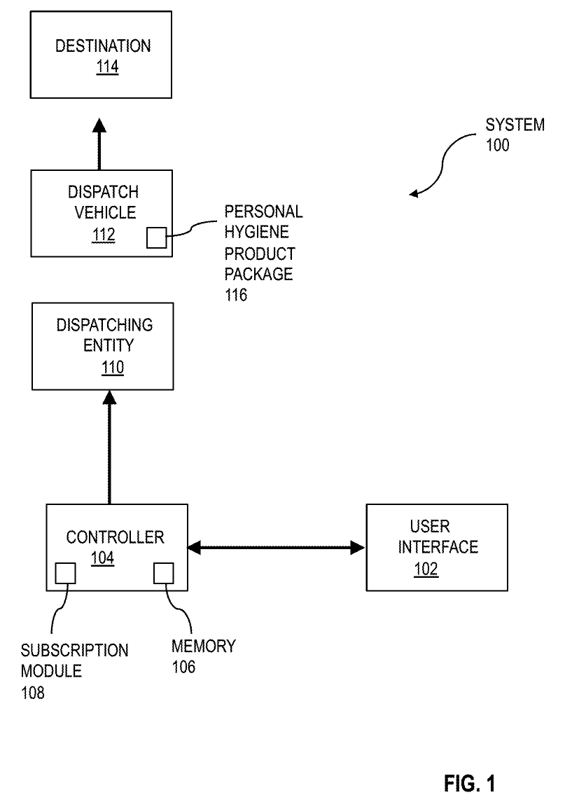

FIG. 1 is a block diagram that illustrates an example of a system 100 that may perform a delivery management method, according to an aspect of the disclosure. As shown in FIG. 1, the system 100 may include a user interface 102 that is communicatively coupled with a controller 104. In one example, the user interface 102 may be a touchscreen display of a mobile device. The user interface 102 may be employed for a consumer or a user to provide input to the controller 104 with respect to a consumer product subscription. For example, the user interface 102 may be employed by a consumer to request a consumer product subscription or to provide other input (e.g. request additional shipments of consumer products) for the subscription. The user interface 102 may also be employed in order to communicate information to the consumer from the controller 104 (e.g. communicate a next shipment date, communicate a subscription cost, etc.).

Although a consumer may use the user interface 102 to request the consumer subscription, in other examples a party other than the consumer may use the user interface 102 to request the consumer subscription to be given to a consumer (e.g. as a gift). In still another example, although the consumer product subscription disclosed herein may be for a single user, in other examples the consumer product subscription may be for a group of users, such as a family.

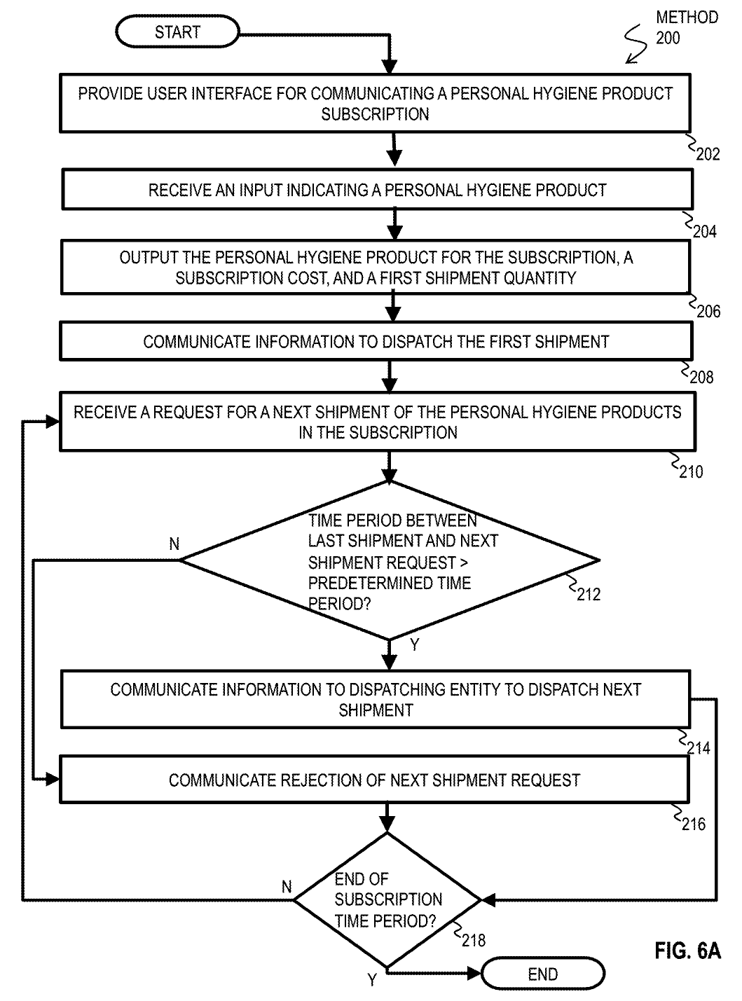

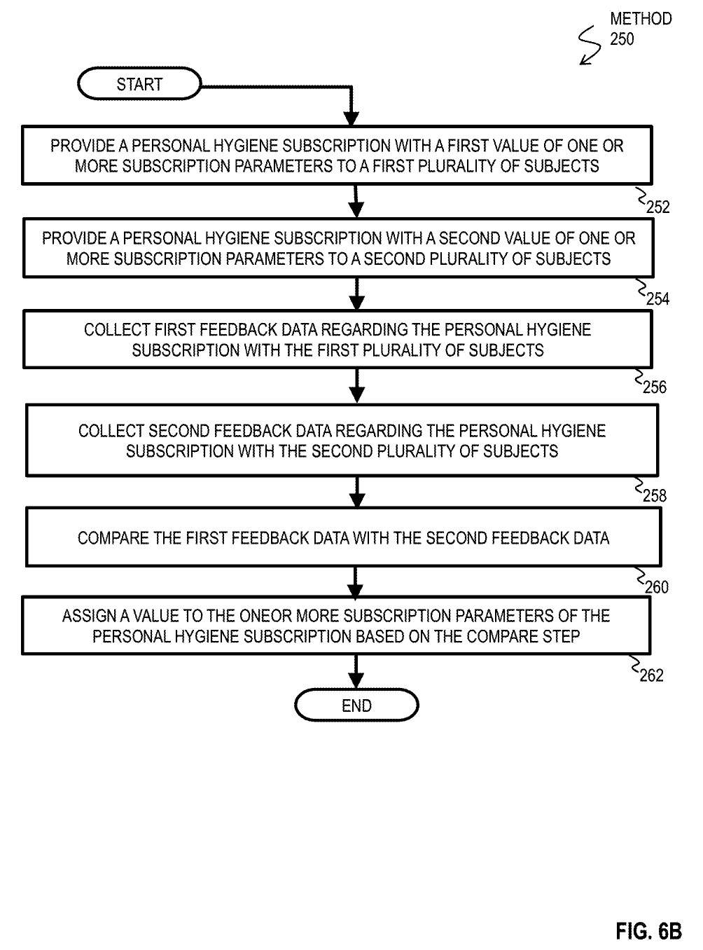

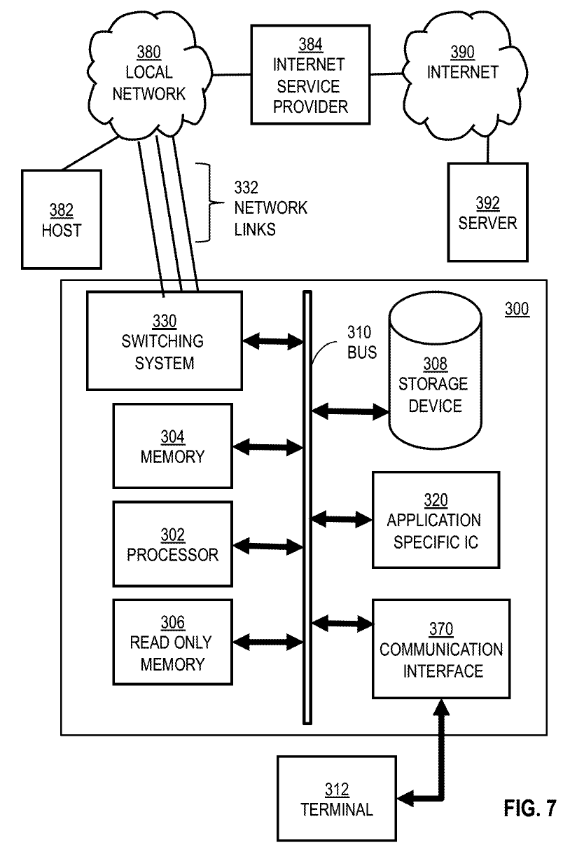

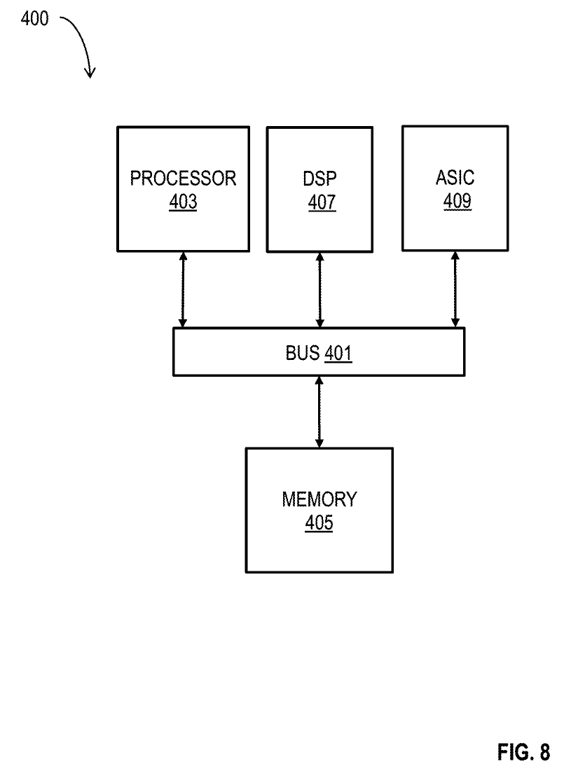

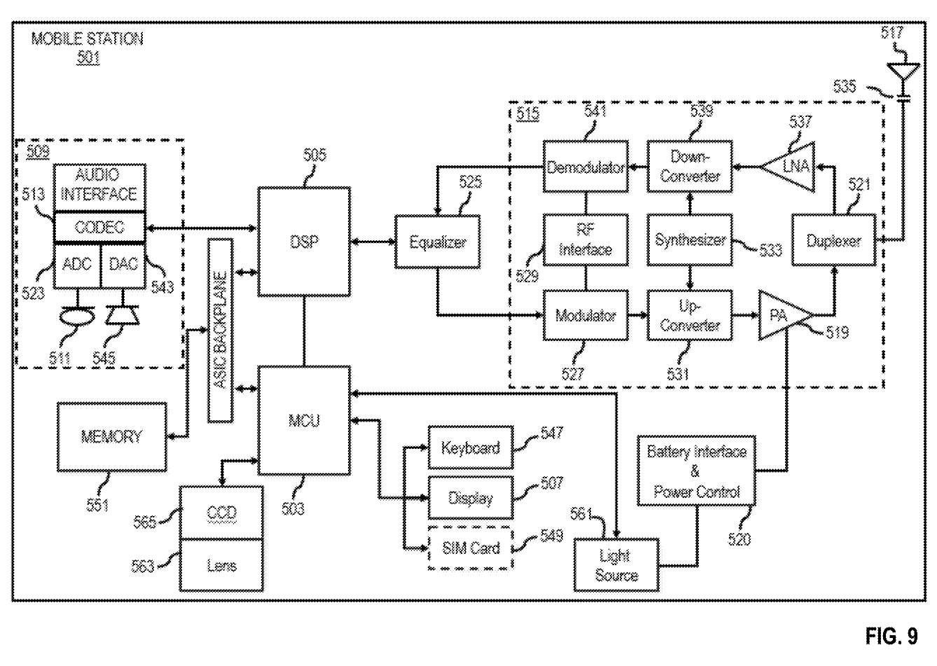

As shown in FIG. 1, the controller 104 may include a memory 106 to store data in relation to the performance of the delivery management method. The controller 104 may also include a subscription module 108 that may include a set of one or more instructions that cause the controller 104 to perform one or more steps of a method, such as the method 200 of the flowchart depicted in FIG. 6A and/or the method 250 of the flowchart depicted in FIG. 6B. In some examples, the processor or controller 104 may be a computer system as described below with reference to FIG. 7, a chip set described below with reference to FIG. 8 or a mobile terminal described below with reference to FIG. 9. Similarly, in some examples, the user interface 102 may be a user interface of the mobile terminal (e.g. display 507) described with reference to FIG. 9.

As further shown in FIG. 1, the system 100 may include a dispatching entity 110. The dispatching entity 110 may be a manufacturer of the consumer products for the product hygiene product subscription or a third party retailer of the consumer products for the product hygiene product subscription. The dispatching entity 110 may feature a dispatch vehicle 112 that is configured to transport a package 116 of consumer products to a destination 114.

The dispatching entity 110 may be communicatively coupled with the controller 104. The controller 104 may communicate information related to one or more shipments of the consumer product subscription to the dispatching entity 110 in order to cause the dispatching entity 110 to dispatch the respective one or more shipments of the consumer product subscription. As discussed in greater detail herein, the controller 104 may automatically transmit information to the dispatching entity 110 related to a first shipment of the consumer product subscription in order to automatically cause the dispatching entity 110 to dispatch the first shipment. The controller 104 may transmit information to the dispatching entity 110 related to subsequent shipments (e.g. second shipment) of the hygiene product subscription to cause the dispatching entity 110 to dispatch subsequent shipments of the hygiene product subscription, if certain criteria are met. In one example, these criteria may include a determination by the controller 104 as to whether a time period between a most recent shipment of the consumer products and a next request (e.g. received via the user interface 102) for a next shipment of the consumer products is greater than or equal to a predetermined time period.

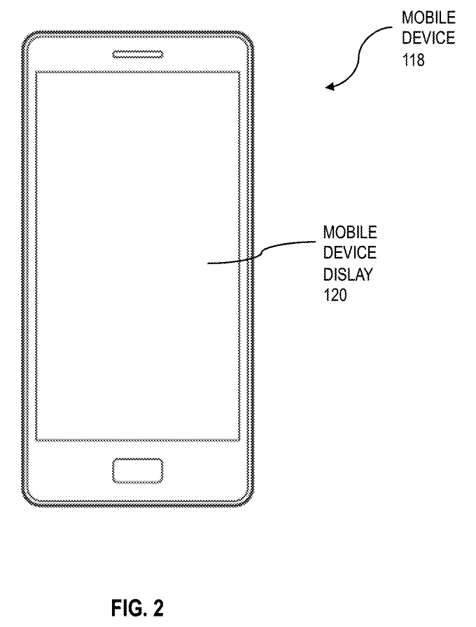

One example of the user interface 102 of the system 100 of FIG. 1 will now be discussed. FIG. 2 is a schematic diagram that illustrates an example of a mobile device 118 that may be used in the system 100 of FIG. 1, according to an aspect of the disclosure. In this example, the user interface 102 of FIG. 1 may be provided by outputting the user interface 102 on a display 120 (e.g. touchscreen display) of the mobile device 118. Input may be provided from the user interface 102 to the controller 104 by the user employing the touchscreen display 120 to select one or more active areas or icons on the display 120. Similarly, an output may be provided from the controller 104 to the user interface 102 by outputting data on the display 120 which can then be viewed by the user.

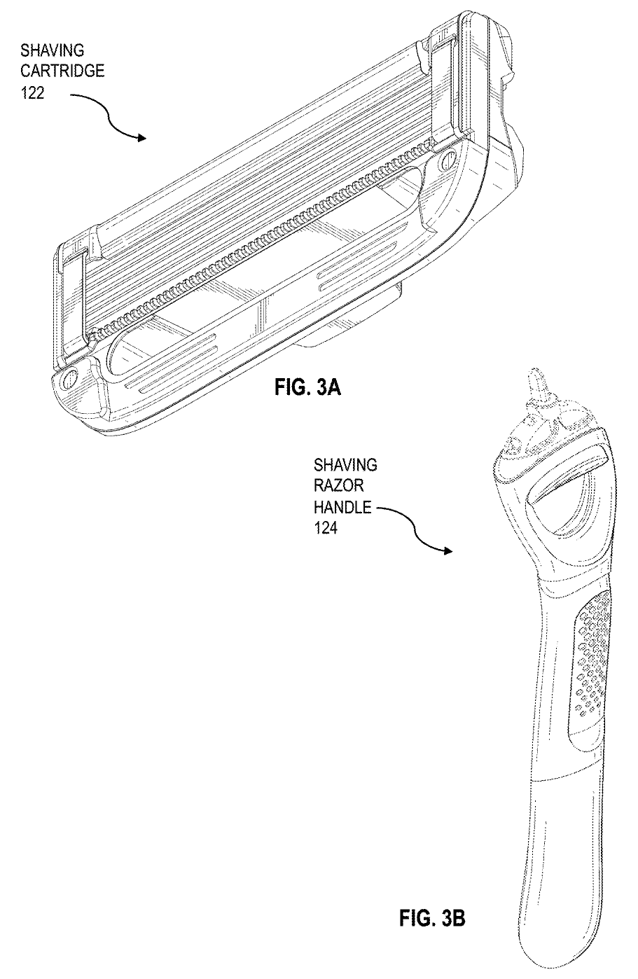

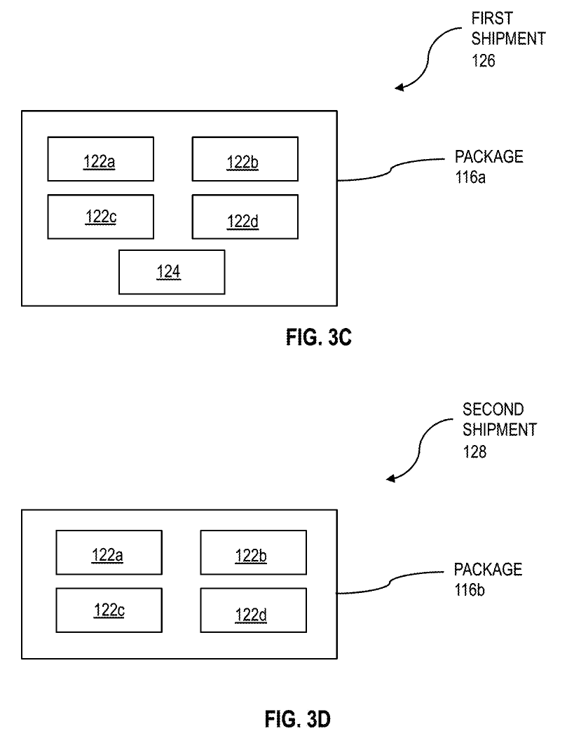

One example of a consumer product for the consumer product subscription is now discussed. FIGS. 3A and 3B are perspective views that illustrate an example of a razor cartridge 122 and shaving razor handle 124 that may be delivered in the delivery management method, according to an aspect of the disclosure. The razor cartridge 122 may be removably attached to the shaving razor handle 124. Although FIGS. 3A and 3B depict one type of razor cartridge 122, the delivery management method disclosed herein can be used to manage subscriptions for multiple types of razor cartridges 122. In one example, the consumer product subscription herein may be based on a subscription for razor cartridges 122, where a consumer may receive one or more shipments of razor cartridges 122 over a subscription time period. A first shipment of the razor cartridges 122 may be automatically shipped when the consumer orders the razor cartridge subscription and subsequent shipments thereafter may be dispatched if certain criteria are met, as disclosed herein. In one example, when the consumer orders the razor cartridge subscription, the consumer may optionally select whether they want the shaving razor handle 124 (which is configured to fit the razor cartridge 122 of the subscription) to be dispatched in a first or subsequent shipment of the razor cartridge subscription.

Although FIGS. 3A and 3B depict the razor cartridge 122 that may be the consumer product of the consumer product subscription herein, in other examples other consumer products may be subject of the consumer product subscription. Such consumer products may include, but are not limited to one or more of toothbrushes, shaving razor cartridges, toothpaste, hair care products, household cleaning products, feminine hygiene products, diapers, baby care products, toilet paper, paper towels, insect traps and repellants, perfume, dental care products, body cleansing and moisturizing products.

Some example packaging of consumer products of the consumer product subscription are now discussed herein. FIGS. 3C and 3D are schematic views that illustrate an example of packages 116a, 116b of razor cartridges 122 that may be dispatched in a first and second shipment 126, 128 of the delivery management method, according to an aspect of the disclosure. When ordering the razor cartridge subscription, a consumer may request a quantity of razor cartridges 122 in each shipment of the razor cartridge subscription. In one example, the consumer may select the quantity of razor cartridges 122 in each shipment based on selecting from one or more predetermined threshold quantities (e.g. 2, 4, 6, etc.) with the user interface 102. In other examples, the razor cartridge subscription may feature a fixed number of razor cartridges 122 in each shipment (e.g. between 2 and 6), which is predetermined as a feature of the subscription. As shown in FIG. 3C, the package 116a of a first shipment 126 of the razor cartridge subscription may feature four razor cartridges 122a through 122d as well as the shaving razor handle 124. The shaving razor handle 124 may be included in the package 116a of the first shipment 126 upon request by the consumer. The package 116b of the second shipment 128 may also feature four razor cartridges 122a through 122d. Although four cartridges are depicted in each package 116a, 116 of the first and second shipment 126, 128 this is merely one example of a fixed quantity of razor cartridges in each shipment and does not limit the delivery management method disclosed herein.

### Delivery Management Method

The delivery management method is now disclosed herein which is used to manage the consumer subscription. The delivery management method may include processing inputs provided by the user to the controller 104 via the user interface 102. The delivery management method may also include providing outputs from the controller 104 to the user interface 102 and thus communicate certain information to the user via the user interface 102.

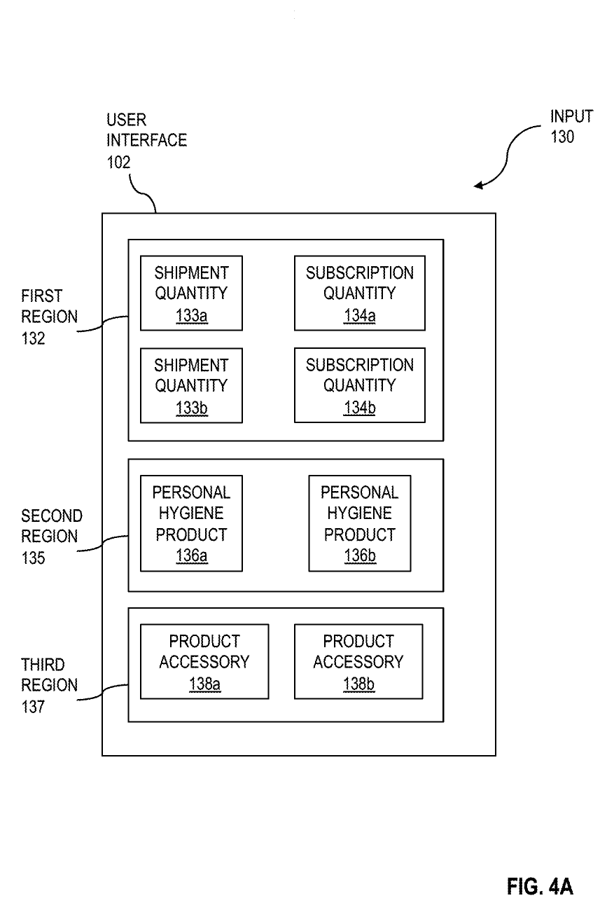

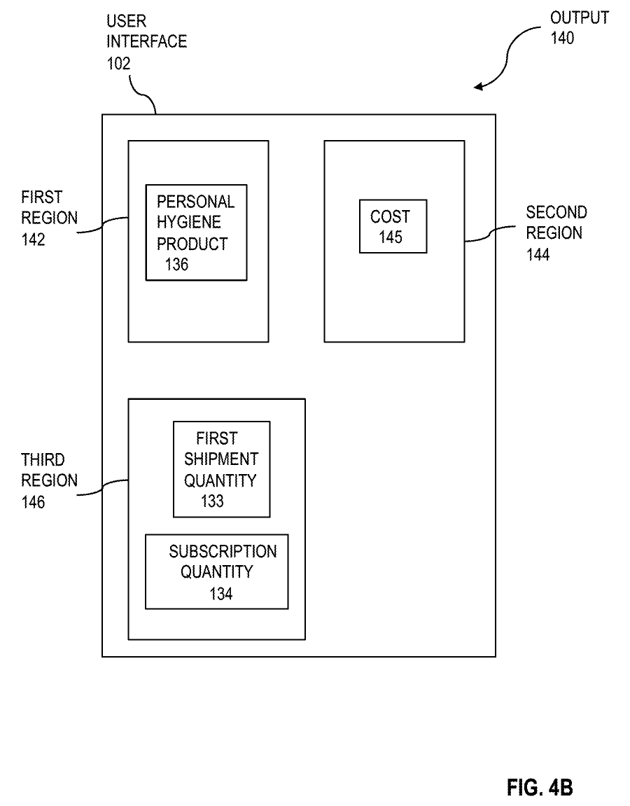

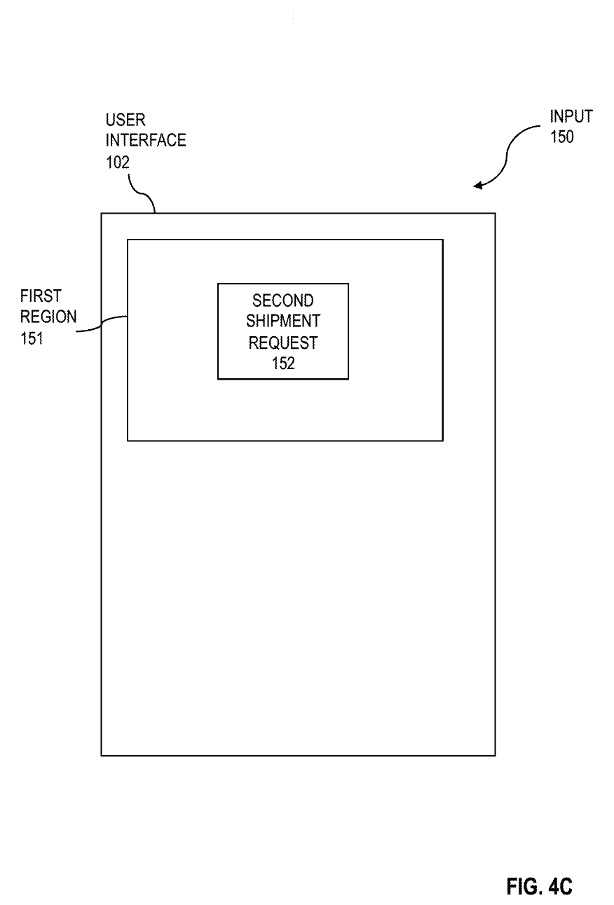

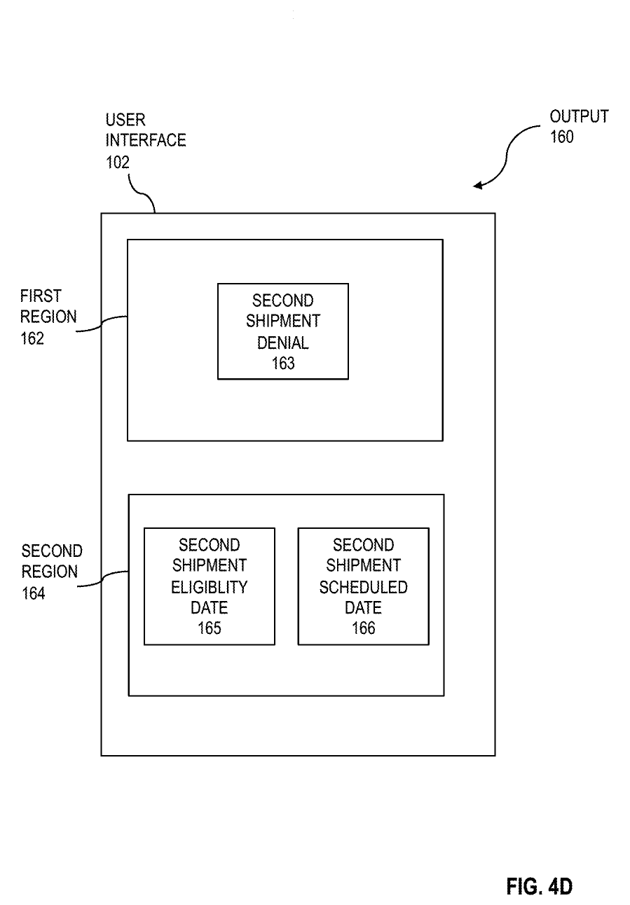

An example of an input provided by the user to the controller 104 via the user interface 102 is now discussed. This input may be used to order the consumer product subscription. In one example, this input may be used to provide an array of consumer product subscriptions, of which the user may select one based on their desired subscription criteria. FIG. 4A is a front view that illustrates an example of an input 130 provided by a user with the user interface 102 when ordering the consumer product subscription.

In one example, the input 130 may feature an option for a user to select a desired quantity of consumer products in each shipment of the subscription. Thus, the input 130 on the user interface 102 may feature a first region 132 with a plurality of active areas 133 that may be used to select a desired quantity of consumer products in each shipment of the subscription. For example, the first active area 133a may indicate a first quantity (e.g. 2) of razor cartridges in each shipment of the subscription whereas the second active area 133b may indicate a second quantity (e.g. 4) of razor cartridges in each shipment of the subscription. In this example, the user may select a desired quantity of razor cartridges in each shipment of the subscription, based on selecting one of the quantities in the active areas 133a, 133b. This input may then be received by the controller 104 and may be used to manage the consumer product subscription. However, in other examples, the razor cartridge subscription may feature a fixed quantity of razor cartridges in each shipment of the subscription. Thus, in this example, the active areas 133 are omitted from the input 130 on the user interface 102.

In another example, the input 130 may feature an option for a user to select a maximum quantity of consumer products in the subscription. Thus, the input 130 on the user interface 102 may feature the first region 132 with a plurality of active areas 134 that may be used to select a maximum quantity of consumer products in the subscription. For example, the first active area 134a may indicate a first maximum quantity (e.g. 12) of razor cartridges in the subscription whereas the second active area 134b may indicate a second maximum quantity (e.g. 24) of razor cartridges in the subscription. In this example, the user may select a maximum quantity of razor cartridges in the subscription, based on selecting one of the maximum quantities in the active areas 134a, 134b. This input may then be received by the controller 104 and may be used to manage the consumer product subscription. However, in other examples, the razor cartridge subscription may feature a fixed maximum quantity (e.g. 12, 18, 24, 32, etc.) of razor cartridges. Thus, in this example, the active areas 134 are omitted from the input 130 on the user interface 102.

In another example, the input 130 may feature an option for a user to select one of a plurality of consumer products for the consumer product subscription. For example, where the consumer product is the razor cartridge 122, the input 130 may feature an option where a user can select one of a plurality of different razor cartridges 122 for the subscription. Thus, as shown in FIG. 4A, the input 130 on the user interface 102 may feature the second region 135 with a plurality of active areas 136 that may be used to select one of a plurality of different consumer products. For example, the first active area 136a may indicate a first type of razor cartridge 122 (e.g. 5 blade, etc.) in the subscription whereas the second active area 136b may feature a second type of razor cartridge 122 (e.g. 3 blade, etc.). In this example, the user may select a desired type of razor cartridge 122 in the subscription, based on selecting one of the active areas 136a, 136b. This input may then be received by the controller 104 and may be used to manage the consumer product subscription. However, in other examples, the razor cartridge subscription may feature a certain type of razor cartridge. Thus, in this example, the active areas 136 are omitted from the input 130 on the user interface 102.

In another example, the input 130 may feature an option for a user to select one of a plurality of accessories for the consumer product subscription. For example, the user may select an accessory for the consumer product subscription which may be dispatched in a first shipment of the subscription along with the consumer products. In one example, the accessory for the consumer product subscription may be the shaving razor handle 124 for the razor cartridge subscription. In this example, the input 130 may feature a third region 137 that may output a plurality of active areas 138a, 138b to indicate a respective plurality of accessories (e.g. shaving razor handles 124) for the consumer product subscription. In one example, the plurality of active areas 138a, 138b may indicate different shaving razor handles 124 which can each fit the selected razor cartridge 122 (from the second region 135) or the razor cartridge 122 of the subscription. In this example, the user may select a desired type of shaving razor handle 124, based on selecting one of the active areas 138a, 138b, which may be included in the package 116a of the first shipment 126 (FIG. 3C). This input may then be received by the controller 104 and may be used to manage the consumer product subscription. However, in other examples, the razor cartridge subscription may not provide the option of adding the accessory (e.g. shaving razor handle 124) to the subscription. Thus, in this example, the active areas 138 are omitted from the input 130 on the user interface 102.

In the above examples, based on the user selecting one or more of the active areas in the input 130 on the user interface 102, the user may select one of an array of consumer product subscriptions. Although the input 130 of FIG. 4A depicts different regions with different active areas, this is merely one example of how the input 130 may be provided with the user interface 102. In other examples, the active areas may be arranged on the user interface 102 in a different manner and/or the input may be provided using means other than active areas (e.g. scanning of QR code). Additionally, although the input 130 in FIG. 4A on the user interface 102 depicts one manner of providing the input criteria of the consumer subscription, the input can be provided in a different manner than the input 130 on the user interface 102, including but not limited to any means of electronic communication appreciated by one skilled in the art (e.g. text, email, etc.).

Although not depicted in FIG. 4A, in some examples the input 130 on the user interface 102 may feature a region for the user to input payment information for the subscription (e.g. credit card information or any other electronic payment method). Additionally, although not depicted in FIG. 4A, in some examples the input 130 on the user interface 102 may feature a region for the user to input delivery information (e.g. address of the destination 114).

Indeed, although two active areas are provided in the various regions of the input 130 of the user interface 102 in FIG. 4A, the aspects of the disclosure are not limited to this quantity of active areas and may feature more than two active areas based on the quantity of each subscription criteria to be selected from.

After the user provides input with the user interface 102, the controller 104 may receive the input data and may output data to the user interface 102 regarding the consumer product subscription ordered by the user. FIG. 4B is a front view that illustrates an example of an output 140 provided by the controller 104 to the user interface 102 after having received the input 130.

As shown in FIG. 4B, the output 140 provided to the user interface 102 may include a first region 142 that indicates the consumer product 136 for the subscription. In this example, the consumer product 136 indicated in the first region 142 of the output 140 may correspond to the selected consumer product in the second region 135 of the input 130. In another example, the consumer product 136 indicated in the first region 142 may correspond to the predetermined consumer product that is the subject of the subscription.

As shown in FIG. 4B, the output 140 provided to the user interface 102 may include a second region 144 that may indicate a cost 145 for the consumer subscription. The cost 145 may depend on one or more of the subscription criteria selected in the input 130 (e.g. shipment quantity, subscription quantity, type of consumer product, optional selection of product accessory).

As shown in FIG. 4B, the output 140 provided to the user interface 102 may include a third region 146 that may indicate the first shipment quantity 133 of the consumer products in the first shipment 126 of the subscription. In another example, the third region 146 may indicate the subscription quantity 134 that is the maximum quantity of consumer products in the subscription. In one example, the first shipment quantity 133 in the third region 146 may correspond to the selected active area 133a, 133b in the first region 132 of the input 130. In another example, the first shipment quantity 133 in the third region 146 may correspond to a predetermined and fixed quantity of consumer products in each shipment for the subscription (e.g. where the quantity is fixed and thus not selected by the user). In one example, the first shipment quantity (and quantity of consumer products in each shipment) may be selected in a range from about 2 to about 6. In one example, the subscription quantity 134 in the third region 146 may correspond to the selected active area 134a, 134b in the first region 132 of the input 130. In another example, the subscription quantity 134 in the third region 146 may correspond to a predetermined and fixed maximum quantity of consumer products in the subscription (e.g. where the quantity is fixed and thus not selected by the user). In one example, the maximum quantity of consumer products in the subscription may be selected in a range from about 8 to about 32.

After receiving the input 130 from the user interface 102, the controller 104 may transmit a signal to the dispatching entity 110 to cause the dispatching entity 110 to dispatch the package 116a of the first shipment 126 of the subscription. In this example, upon receiving the signal from the controller 104, the dispatching entity 110 may cause the dispatch vehicle 112 to transport the package 116a of the first shipment 126 to the destination 114.

After the first shipment 126 of the consumer products in the subscription is dispatched, when the user wants to receive the second shipment 128 of consumer products in the subscription, the user can provide a request for the second shipment 128 of the consumer products in the subscription. As discussed in greater detail below, upon receiving the request for the second shipment 128, the controller 104 determines whether one or more criteria are satisfied and if so, the controller 104 may arrange for the dispatching entity to dispatch the second shipment 128.

The user request for the second shipment 128 will now be discussed. FIG. 4C is a front view that illustrates an example of an input 150 provided by the user with the user interface 102 when requesting a second shipment of the consumer products in the subscription. As shown in FIG. 4C, the input 150 may include a first region 151 with an active area 152 which can be selected by the user to provide the request for the second shipment 128. In one example, upon the user selecting the active area 152, the user interface 102 transmits the request for the second shipment 128 to the controller 104. Although FIG. 4C depicts that the user interface 102 may be used to provide the second shipment request, in other examples the second shipment request may be provided by any means of electronic communication known to one skilled in the art (e.g. text message, email, etc.).

Upon receiving the request for the second shipment of the subscription, the controller 104 may determine whether the request for the second shipment meets one or more criteria. If the request for the second shipment does not meet the one or more criteria, the controller 104 may transmit a rejection of the request for the second shipment to the user interface 102. In one example, as disclosed herein, one of these criteria may involve the controller 104 comparing a time period between the dispatch of the first shipment 126 of the subscription and the receipt of the request for the second shipment with a predetermined time period. If the time period is greater than or equal to the predetermined time period, the controller 104 may transmit a signal to the dispatching entity 110 to cause the second shipment 128 of the consumer products of the subscription to be dispatched. If the time period is less than the predetermined time period, the controller 104 may transmit a signal to the user interface 102 to communicate a rejection of the request for the second shipment of the shaving cartridge subscription.

The predetermined time period may have a value that is selected to be short enough so that the consumer is eligible to receive shipments of the consumer products at an acceptable rate so to not run out of consumer products. Similarly, the predetermined time period may have a value that is long enough to prevent abuse or an excessive amount of shipments of the consumer products in the subscription time period (e.g. so to avoid excess shipping costs to the manufacturer or retailer). In one example, the predetermined time period may be in a range from about 2 weeks to about 4 weeks. In another example, the predetermined time period may be in a range from about 2 weeks to about 6 weeks. In yet another example, the predetermined time period may be selected to be a minimum duration to indicate fraud or abuse of the subscription. In this example, the predetermined time period is set to be adequately long (e.g. 2 weeks or 4 weeks) so to ensure that a user cannot order a large number of shipments of the consumer products over a short time period so to re-sell the consumer products rather than personally use the consumer products.

The communication of the rejection of the request for the second shipment is now discussed herein. FIG. 4D is a front view that illustrates an example of an output 160 provided by the controller 104 to the user interface 102 after the controller 104 rejects the request for the second shipment of the subscription. As shown in FIG. 4D, in one example the output 160 may feature a first region 162 that indicates the second shipment request denial 163. In one example, the denial 163 may feature text or images that communicate to the user that the second shipment request was denied.

The controller 104 may also transmit other information to the user interface 102 in the event of a denial of the second shipment request. In one example, the controller 104 may determine the soonest eligibility date that the second shipment 128 can be dispatched (e.g. the predetermined time period after the first shipment 126) and may automatically schedule the second shipment 128 on that date. In this example, the output 160 on the user interface 102 may feature a second region 164 that may include an indication of the second shipment scheduled date 166. In this example, the memory 106 of the controller 104 may store data to cause the controller 104 to automatically transmit a signal to the dispatching entity 110 on the second shipment scheduled date 166 so that the second shipment 128 is automatically dispatched on that date. In another example, instead of automatically scheduling the second shipment 128 on the second shipment scheduled date 166, the controller 104 may output the soonest date that the second shipment 128 can be dispatched. Thus, in this example the second region 164 may also indicate this second shipment eligibility date 165. The user may then mark their calendar with this date and subsequently re-submit the second shipment request on that date.

Another criteria that may be employed by the controller 104 when deciding whether to approve the second shipment request 152 is comparing a total number of consumer products in the first and second shipments 126, 128 with the maximum quantity 134 of consumer products in the subscription. In this example, if the total number of consumer products in the first and second shipments 126, 128 exceeds the maximum quantity 134 of consumer products in the subscription, the controller 104 may deny the second shipment request 152 and communicate the denial 163 to the user interface 102. Additionally, in this example, if the total number of consumer products in the first and second shipments 126, 128 does not exceed the maximum quantity 134 of consumer products in the subscription, the controller 104 may approve the second shipment request and transmit the signal to the dispatching entity 110 to cause the second shipment 128 of the subscription to be dispatched. In other examples, this criteria may be repeated by the controller 104 for all subsequent shipment requests over the course of the subscription time period. Thus, in this example, upon receiving a third shipment request from the user interface 102 following two shipments of the consumer products, the controller 104 may compare the cumulative total number of consumer products shipped in the first, second and third shipments with the maximum quantity 134 of consumer products. If this cumulative number does not exceed the maximum quantity 134, the controller 104 may approve the third shipment request.

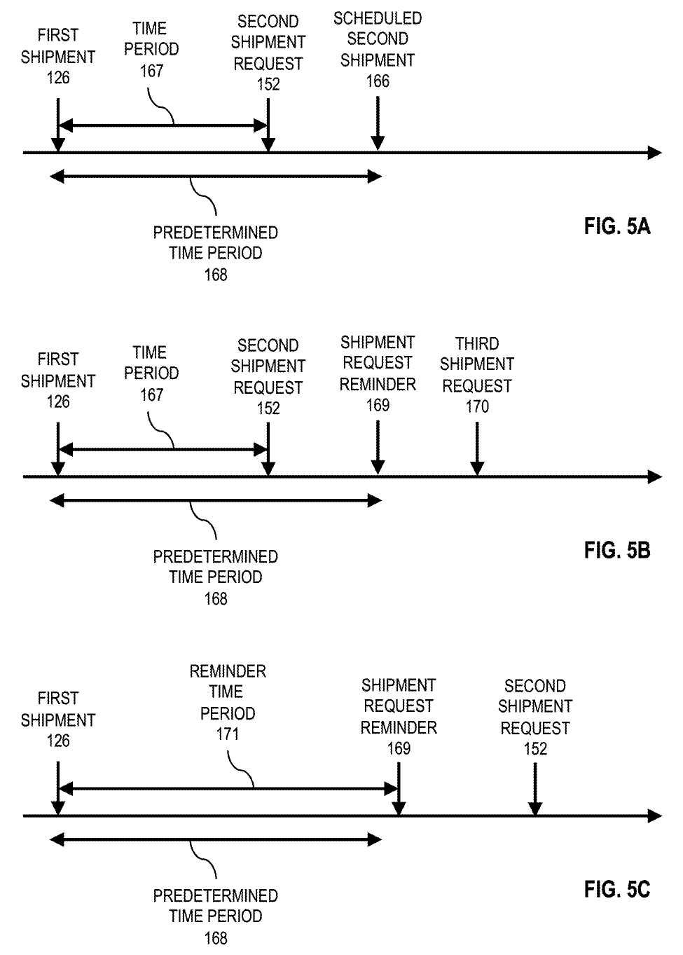

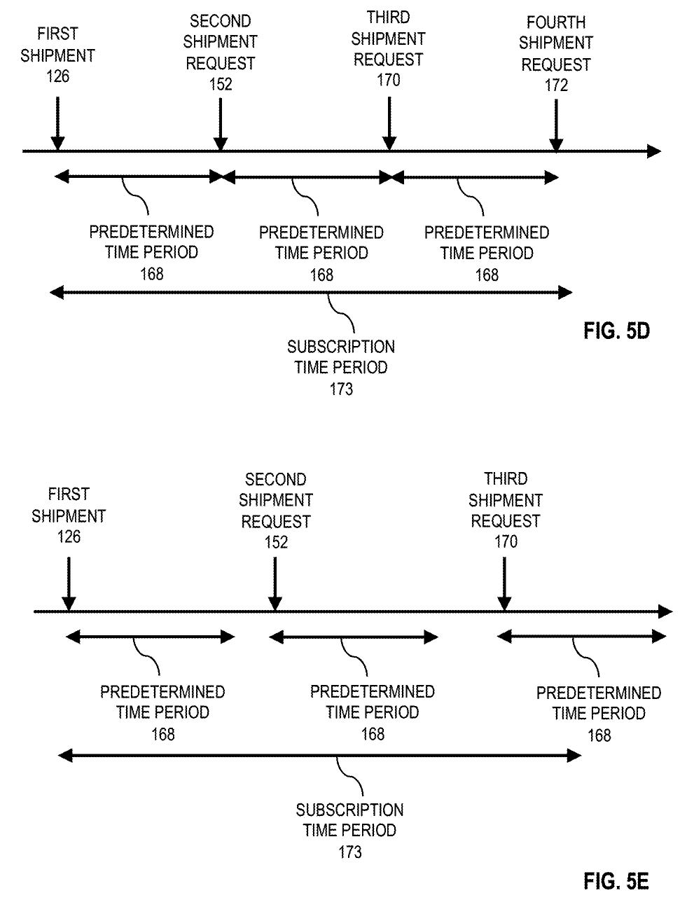

Some timelines are now shown which depict various examples of different sequences of the steps of the delivery management method. FIGS. 5A through 5E are timelines that illustrate an example of various time sequences of the steps of the delivery management method, according to an aspect of the disclosure. The horizonal axis in each of FIGS. 5A through 5E is time (arbitrary units).

In a first example shown in FIG. 5A, the controller 104 may receive the second shipment request 152 at a time period 167 after the dispatch of the first shipment 126. The controller 104 may compare the time period 167 with the predetermined time period 168. As shown in FIG. 5A, the controller 104 may determine that the time period 167 is less than the predetermined time period 168 and thus may deny the second shipment request 152. In addition to outputting the second shipment denial 163 on the user interface 102, the controller 104 may schedule the second shipment 128 on the second shipment scheduled date 166. As shown in FIG. 5A, the second shipment scheduled date 166 is a date that is at least the predetermined time period 168 after the first shipment 126.

In a second example shown in FIG. 5B, the controller 104 may receive the second shipment request 152 at a time period 167 after the dispatch of the first shipment 126. The controller 104 may compare the time period 167 with the predetermined time period 168. As shown in FIG. 5B, the controller 104 may determine that the time period 167 is less than the predetermined time period 168 and thus may deny the second shipment request 152. In addition to outputting the second shipment denial 163 on the user interface 102, the controller 104 may schedule a reminder 169 to be sent to the user interface 128 to re-submit the shipment request. As shown in FIG. 5B, the reminder 169 may be sent to the user interface 102 when the second shipment is eligible, i.e., on a date that is at least the predetermined time period 168 after the first shipment 126. As further shown in FIG. 5B, in this example, upon receiving the reminder 169 to submit the shipment request, the user may submit a third shipment request 170 using the user interface 102. For purposes of FIG. 5B, the shipment request 170 is referred to as a “third” shipment request since it is preceded by two prior shipment requests. Thus, although the shipment request 170 is a third shipment request, it is a request for a second shipment 128 of the consumer products.

In a third example shown in FIG. 5C, if the controller 104 does not receive the second shipment request 152 after the predetermined time period 168 has elapsed after the first shipment 128, the controller 104 may transmit a reminder 169 for the user to submit the second shipment request via. the user interface 102. In this example, the reminder 169 is transmitted to the user via the user interface 102 at a reminder time period 171 after the first shipment 130 but prior to receipt of the second shipment request 152. Although FIG. 5C depicts that the reminder time period 171 is greater than the predetermined time period 168, in other examples the reminder time period 171 may be less than the predetermined time period 168. In one example, the reminder time period 171 may be in a range from about 1 month to about 4 months.

A fourth example shown in FIG. 5D depicts a plurality of shipment requests input by a user over the subscription time period 173 (e.g. one year). As shown in the example of FIG. 5D, after the dispatch of the first shipment 128, the user may request subsequent shipments at regular increments corresponding to the predetermined time period 168. Consequently, the controller 104 may approve each subsequent shipment request 152, 170, 172, since each subsequent shipment request is submitted after the previous shipment by at least the predetermined time period 168. This example depicts how the consumer product subscription may involve a maximum number of shipments (e.g. four in the example of FIG. 5D). This advantageously prevents excess shipping costs to the manufacturer or retailer of the consumer products. As shown in the example of FIG. 5D, the maximum number of shipments over the subscription time period 173 may correspond to the subscription time period 173 divided by the predetermined time period 168. Although FIG. 5D depicts that a maximum of four shipments may occur over the predetermined time period 168, this is merely for ease of illustration and thus the maximum number of shipments may differ than what is depicted in FIG. 5D. In one example, the subscription time period 173 may be about one year and the predetermined time period 168 may be one month and thus a maximum of 12 shipments may occur over the subscription. As shown in the example of FIG. 5E, where a user submits one or more of the shipment requests after the predetermined time period 168 has elapsed from the previous shipment, the number of shipments (e.g. three) over the subscription time period 173 is reduced from the maximum number of shipments (e.g. four). This advantageously saves shipping costs to the manufacturer or retailer still providing the user with razor cartridges as they are needed.

In another example, a maximum number of shipments over the subscription time period 173 may correspond to the maximum quantity 134 of consumer products over the course of the subscription time period 173 divided by the quantity 133 of consumer products in each shipment. In one example, where the maximum quantity 134 of razor cartridges 122 is 24 over the subscription and the quantity 133 of razor cartridges 122 in each shipment is 4, there may be a maximum of 6 shipments over the course of the subscription time period 173. As previously disclosed, this advantageously ensures that the manufacturer or retailer of the consumer products may not absorb excess shipping costs and/or that the subscription is not vulnerable to abuse or fraud (e.g. due to consumers re-selling the consumer products rather than using them).

FIG. 6A is a flowchart that illustrates an example of various steps of the delivery management method 200, according to an aspect of the disclosure. Although the flow diagram of FIG. 6A may be depicted as integral steps in a particular order for purposes of illustration, in other aspects one or more steps, or portions thereof, are performed in a different order, or overlapping in time, in series or in parallel, or are deleted, or one or more other steps may be added, or the method may be changed in some combination of ways.

In step 202, the user interface may be provided for communicating a consumer product subscription. In one example, in step 202 the user interface 102 of the system 100 may be provided. In one example, in step 202 the user interface is provided via. a display 120 (e.g. touchscreen display) of a mobile device 118.

In step 204, an input may be received that indicates the consumer product for the consumer product subscription. In one example, in step 204 the controller 104 may receive the input 130 from the user interface 102 that identifies one or more of the shipment quantity 133, the subscription quantity 134, the consumer product 136 (e.g. razor cartridge 122) and/or the product accessory 138 (e.g. shaving razor handle 124) for the subscription.

In step 206, an output may be provided that indicates one or more parameters of the subscription. In one example, in step 206 the output may be provided that indicates one or more of the consumer product 136 (e.g. shaving cartridge 122), the cost 145, the first shipment quantity 133 and/or the subscription quantity 134 for the subscription. In one example, in step 206 the output 140 may be provided to the user interface 102.

In step 208, information may be communicated to dispatch the first shipment of the subscription. In one example, in step 208 the controller 104 may transmit a signal to the dispatching entity 110 to cause the first shipment 126 of the consumer products in the subscription to be dispatched. In an example, step 208 may be automatic upon receiving the input in step 204 for the subscription.

In step 210, an input may be received of a second shipment request. In one example, in step 210 the controller 104 may receive the input 150 from the user interface 102 including the second shipment request 152.

In step 212, a time period between the dispatch of the first shipment (of step 208) and the receipt of the second shipment request (of step 210) may be compared with the predetermined time period. In one example, if the time period if greater than or equal to the predetermined time period, the method 200 may move to step 214. In this example, if the time period is less than the predetermined time period, the method 200 may move to step 216. In the example of FIGS. 5A and 5B, in step 212 the controller 104 may compare the time period 167 between the first shipment 126 and second shipment request 152 with the predetermined time period 168.

In another example, in step 212 additional criteria may be assessed. For example, in step 212 the controller 104 may determine whether a cumulative number of consumer products in both the first and second shipments exceed the maximum number 134 of consumer products in the subscription. In this example, if the cumulative number of consumer products does not exceed the maximum number 134, then the method 200 may move to step 214. Also, in this example, if the cumulative number of consumer products does exceed the maximum number 134, then the method 200 may move to step 216.

In step 214, upon determining that the time period of step 212 is greater than or equal to the predetermined time period, the second shipment request may be approved. In this example, in step 214 the controller 104 may transmit a signal to the dispatching entity 110 to cause the second shipment to be dispatched. The method 200 may then move to step 218.

In step 216, upon determining that the time period of step 212 is less than the predetermined time period, the second shipment request may be denied. In this example, in step 216 the controller 104 may transmit a signal to the user interface 102 to cause the output 160 to be displayed on the user interface 102 that may include the second shipment denial 163 being communicated to the user. The method 200 may then move to step 218.

In step 218, a determination may be made as to whether the subscription has ended. In an example, in step 218 the controller 104 may determine whether the subscription time period 173 has elapsed. If this determination is in the affirmative, the method 200 may end. If this determination is in the negative, then the method 200 may proceed back to step 210. In this example, the method 200 may then process a next shipment request (e.g. third shipment request) and repeat steps 210 through 216 for this next shipment request.

The method disclosed herein may provide several advantages to the consumer of the consumer goods. For example, there is a need for providing consumers with a more consistent shave by ensuring that they have ready access to a new razor cartridge. In one example, the method may place the consumer in control of how many consumer goods (e.g. razor cartridges) they receive, how often, without having to worry about making a payment each time the consumer needs additional consumer goods. Thus, in one example where the consumer goods are razor cartridges, the method may provide the advantages of separating the pain of paying more for additional razor cartridges from the pain of a bad shave (e.g. due to using razor cartridges beyond their use cycle in order to avoid additional payment for more razor cartridges). In this example, the method advantageously may provide the consumer with additional razor cartridges, and thus avoid the pain of a bad shave, without having to experience the pain of making additional payments (e.g. since an initial payment was made upfront for the duration of the shaving cartridge subscription). Consequently, the method disclosed herein may allow a consumer of razor cartridges to get back to their best shave as soon as the razor cartridges start to dull, at no additional cost.

Yet further , another advantage of the disclosed method herein may involve the consumer not ending up with too many consumer goods (e.g. razor cartridges) when they do not need them. This is a routine occurrence with conventional consumer good subscriptions, which ship additional consumer goods to the consumer at regular fixed time intervals, irrespective of whether the consumer has a present need for such additional consumer goods.

In still another advantage of the disclosed method herein, the consumer may avoid having to travel to a retail store to purchase additional consumer goods (e.g. additional razor cartridges) and thus need not contend with locked shelves, sticker shock and not knowing which razor cartridge will fit their handle.

In yet another advantage of the disclosed method herein, the consumer good subscription may be provided to another consumer as a gift.

### Calibration of the Delivery Management Method

The consumer product subscription disclosed herein may feature one or more parameters who are each assigned a value. These parameters may include but are not limited to one or more of the quantity 133 of consumer products in each shipment, the maximum quantity 134 of consumer products over the subscription time period, the predetermined time period 168, the subscription time period 173 and a cost of the subscription (which may depend on values of the other parameters).

A method was developed to determine the value of one or more of these subscription parameters, so to achieve an ideal balance between maximizing user satisfaction while simultaneously minimizing shipping costs to the manufacturer or retailer of the consumer products. FIG. 6B is a flowchart that illustrates an example of various steps of a method 250 for calibrating the consumer product subscription of the delivery management method, according to an aspect of the disclosure. Although the flow diagram of FIG. 6B may be depicted as integral steps in a particular order for purposes of illustration, in other aspects one or more steps, or portions thereof, are performed in a different order, or overlapping in time, in series or in parallel, or are deleted, or one or more other steps may be added, or the method may be changed in some combination of ways.

In step 252, a consumer product subscription having a first value of the subscription parameters may be provided to a first plurality of subjects. In one example, in step 252 the consumer product subscription provided to the first plurality of subjects may feature a first value (e.g. 2) of the quantity 133 of consumer products in each shipment and/or a first value (e.g. 12) of the maximum quantity 134 of the consumer products in the subscription. However, in other examples, the consumer product subscription provide in step 252 may have different parameter values than discussed in the example herein.

In step 254, a consumer subscription having a second value of the subscription parameters may be provided to a second plurality of subjects. In one example, in step 254 the consumer subscription provided to the second plurality of subjects may feature a second value (e.g. 4) of the quantity 133 of consumer products in each shipment and a second value (e.g. 24) of the maximum quantity 134 of the consumer products in the subscription. However, in other examples, the consumer product subscription provided in step 254, may have different parameter values than discussed in the example herein.

In step 256, feedback data is received from the first plurality of subjects regarding the consumer product subscription having the first value. In an example, this feedback data may be collected during or after the subscription time period. In one example, this feedback data may include a rate at which the first plurality of subjects resubscribed to the consumer product subscription (e.g. 60%). In another example, this feedback data may include survey data that solicits from each of the first plurality of subjects regarding the consumer product subscription (e.g. a rating from 1 to 10 in terms of satisfaction, such as 6).

In step 258, feedback data is provided from the second plurality of subjects regarding the consumer product subscription having the second value. In an example, this feedback data may be collected during or after the subscription time period. In one example, this feedback data may include a rate at which the second plurality of subjects resubscribed to the consumer product subscription (e.g. 80%). In another example, this feedback data may include survey data that solicits from each of the second plurality of subjects regarding the consumer product subscription (e.g. a rating from 1 to 10 in terms of satisfaction, such as 8).

In step 260, the feedback data in step 256 from the first plurality of subjects is compared with the feedback data in step 258 from the second plurality of subjects. In one example, in step 260 the resubscription rate from the first plurality of subjects (e.g. 60%) is compared with the resubscription rate from the second plurality of subjects (e.g. 80%).

In step 262, the value of the one or more parameters of the consumer product subscription are assigned, based on the comparison in step 260. In one example, in step 262 since the resubscription rate of the second plurality of subjects (e.g. 80%) is greater than the resubscription rate of the first plurality of subjects (e.g. 60%), the value of the one or more parameters of the consumer subscription may be assigned similar values as the second value of the parameters in the subscription provided to the second plurality of subjects. In this example, the assigned values from step 262 may then be employed for the consumer subscription enacted in the delivery management method disclosed herein.

Although the example discussed herein features the method 250 being performed for two groups of subjects being provided hygiene product subscriptions with different values of the shipment quantity 133 and maximum quantity 134 parameter values, in other examples the method 250 may be performed using any of the other subscription parameters.

### Hardware

FIG. 7 may be a block diagram that illustrates a computer system 300 upon which an embodiment of the invention may be implemented. Computer system 300 includes a communication mechanism such as a bus 310 for passing information between other internal and external components of the computer system 300. Information may be represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena may represent digits of a higher base. A superposition of multiple simultaneous quantum states before measurement represents a quantum bit (qubit). A sequence of one or more digits constitutes digital data that may be used to represent a number or code for a character. In some embodiments, information called analog data may be represented by a near continuum of measurable values within a particular range. Computer system 300, or a portion thereof, constitutes a means for performing one or more steps of one or more methods described herein.

A sequence of binary digits constitutes digital data that may be used to represent a number or code for a character. A bus 310 includes many parallel conductors of information so that information may be transferred quickly among devices coupled to the bus 310. One or more processors 302 for processing information are coupled with the bus 310. A processor 302 performs a set of operations on information. The set of operations includes bringing information in from the bus 310 and placing information on the bus 310. The set of operations also typically include comparing two or more units of information, shifting positions of units of information, and combining two or more units of information, such as by addition or multiplication. A sequence of operations to be executed by the processor 302 constitutes computer instructions.

Computer system 300 also includes a memory 304 coupled to bus 310. The memory 304, such as a random access memory (RAM) or other dynamic storage device, stores information including computer instructions. Dynamic memory allows information stored therein to be changed by the computer system 300. RAM allows a unit of information stored at a location called a memory address to be stored and retrieved independently of information at neighboring addresses. The memory 304 may be also used by the processor 302 to store temporary values during execution of computer instructions. The computer system 300 also includes a read only memory (ROM) 306 or other static storage device coupled to the bus 310 for storing static information, including instructions, that may not be changed by the computer system 300. Also coupled to bus 310 may be a non-volatile (persistent) storage device 308, such as a magnetic disk or optical disk, for storing information, including instructions, that persists even when the computer system 300 may be turned off or otherwise loses power.

Information, including instructions, may be provided to the bus 310 for use by the processor from an external input device 312, such as a keyboard containing alphanumeric keys operated by a human user, or a sensor. A sensor detects conditions in its vicinity and transforms those detections into signals compatible with the signals used to represent information in computer system 300. Other external devices coupled to bus 310, used primarily for interacting with humans, include a display device 314, such as a cathode ray tube (CRT) or a liquid crystal display (LCD), for presenting images, and a pointing device 316, such as a mouse or a trackball or cursor direction keys, for controlling a position of a small cursor image presented on the display 314 and issuing commands associated with graphical elements presented on the display 314.

In the illustrated embodiment, special purpose hardware, such as an application specific integrated circuit (IC) 320, may be coupled to bus 310. The special purpose hardware may be configured to perform operations not performed by processor 302 quickly enough for special purposes. Examples of application specific ICs include graphics accelerator cards for generating images for display 314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 300 also includes one or more instances of a communications interface 370 coupled to bus 310. Communication interface 370 provides a two-way communication coupling to a variety of external devices that operate with their own processors, such as printers, scanners and external disks. In general, the coupling may be with a network link 378 that may be connected to a local network 380 to which a variety of external devices with their own processors are connected. For example, communication interface 370 may be a parallel port or a serial port or a universal serial bus (USB) port on a personal computer. In some embodiments, communications interface 370 may be an integrated services digital network (ISDN) card or a digital subscriber line (DSL) card or a telephone modem that provides an information communication connection to a corresponding type of telephone line. In some embodiments, a communication interface 370 may be a cable modem that converts signals on bus 310 into signals for a communication connection over a coaxial cable or into optical signals for a communication connection over a fiber optic cable. As another example, communications interface 370 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 370 sends and receives electrical, acoustic or electromagnetic signals, including infrared and optical signals, that carry information streams, such as digital data.

The term computer-readable medium may be used herein to refer to any medium that participates in providing information to processor 302, including instructions for execution. Such a medium may take many forms, including, but not limited to, non-volatile media, volatile media and transmission media. Non-volatile media include, for example, optical or magnetic disks, such as storage device 308. Volatile media include, for example, dynamic memory 304. Transmission media include, for example, coaxial cables, copper wire, fiber optic cables, and waves that travel through space without wires or cables, such as acoustic waves and electromagnetic waves, including radio, optical and infrared waves. The term computer-readable storage medium may be used herein to refer to any medium that participates in providing information to processor 302, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer may read. The term non-transitory computer-readable storage medium may be used herein to refer to any medium that participates in providing information to processor 302, except for carrier waves and other signals.

Logic encoded in one or more tangible media includes one or both of processor instructions on a computer-readable storage media and special purpose hardware, such as ASIC *320.

Network link 378 typically provides information communication through one or more networks to other devices that use or process the information. For example, network link 378 may provide a connection through local network 380 to a host computer 382 or to equipment 384 operated by an Internet Service Provider (ISP). ISP equipment 384 in turn provides data communication services through the public, world-wide packet-switching communication network of networks now commonly referred to as the Internet 390. A computer called a server 392 connected to the Internet provides a service in response to information received over the Internet. For example, server 392 provides information representing video data for presentation at display 314.

The disclosure may be related to the use of computer system 300 for implementing the techniques described herein. According to one embodiment of the invention, those techniques are performed by computer system 300 in response to processor 302 executing one or more sequences of one or more instructions contained in memory 304. Such instructions, also called software and program code, may be read into memory 304 from another computer-readable medium such as storage device 308. Execution of the sequences of instructions contained in memory 304 causes processor 302 to perform the method steps described herein. In alternative embodiments, hardware, such as application specific integrated circuit 320, may be used in place of or in combination with software to implement the invention. Thus, embodiments of the invention are not limited to any specific combination of hardware and software.

The signals transmitted over network link 378 and other networks through communications interface 370, carry information to and from computer system 300. Computer system 300 may send and receive information, including program code, through the networks 380, 390 among others, through network link 378 and communications interface 370. In an example using the Internet 390, a server 392 transmits program code for a particular application, requested by a message sent from computer 300, through Internet 390, ISP equipment 384, local network 380 and communications interface 370. The received code may be executed by processor 302 as it may be received or may be stored in storage device 308 or other non-volatile storage for later execution, or both. In this manner, computer system 300 may obtain application program code in the form of a signal on a carrier wave.

Various forms of computer readable media may be involved in carrying one or more sequence of instructions or data or both to processor 302 for execution. For example, instructions and data may initially be carried on a magnetic disk of a remote computer such as host 382. The remote computer loads the instructions and data into its dynamic memory and sends the instructions and data over a telephone line using a modem. A modem local to the computer system 300 receives the instructions and data on a telephone line and uses an infra-red transmitter to convert the instructions and data to a signal on an infra-red a carrier wave serving as the network link 378. An infrared detector serving as communications interface 370 receives the instructions and data carried in the infrared signal and places information representing the instructions and data onto bus 310. Bus 310 carries the information to memory 304 from which processor 302 retrieves and executes the instructions using some of the data sent with the instructions. The instructions and data received in memory 304 may optionally be stored on storage device 308, either before or after execution by the processor 302.

FIG. 8 illustrates a chip set 400 upon which an embodiment of the invention may be implemented. Chip set 400 may be programmed to perform one or more steps of a method described herein and includes, for instance, the processor and memory components described with respect to FIG. 1 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It may be contemplated that in certain embodiments the chip set may be implemented in a single chip. Chip set 400, or a portion thereof, constitutes a means for performing one or more steps of a method described herein.

In one embodiment, the chip set 400 includes a communication mechanism such as a bus 401 for passing information among the components of the chip set 400. A processor 403 has connectivity to the bus 401 to execute instructions and process information stored in, for example, a memory 405. The processor 403 may include one or more processing cores with each core configured to perform independently. A multi-core processor enables multiprocessing within a single physical package. Examples of a multi-core processor include two, four, eight, or greater numbers of processing cores. Alternatively, or in addition, the processor 403 may include one or more microprocessors configured in tandem via the bus 401 to enable independent execution of instructions, pipelining, and multithreading. The processor 403 may also be accompanied with one or more specialized components to perform certain processing functions and tasks such as one or more digital signal processors (DSP) 407, or one or more application-specific integrated circuits (ASIC) 409. A DSP 407 typically may be configured to process real-world signals (e.g., sound) in real time independently of the processor 403. Similarly, an ASIC 409 may be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 403 and accompanying components have connectivity to the memory 405 via the bus 401. The memory 405 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 405 also stores the data associated with or generated by the execution of one or more steps of the methods described herein.

FIG. 9 may be a diagram of exemplary components of a mobile terminal 500 (e.g.,

cell phone handset) for communications, which may be capable of operating in the system of FIG. 1, according to one embodiment. In some embodiments, mobile terminal 501, or a portion thereof, constitutes a means for performing one or more steps described herein. Generally, a radio receiver may be often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 503, a Digital Signal Processor (DSP) 505, and a receiver/transmitter unit including a microphone gain control unit and a speaker gain control unit. A main display unit 507 provides a display to the user in support of various applications and mobile terminal functions that perform or support the steps as described herein. The display 507 includes display circuitry configured to display at least a portion of a user interface of the mobile terminal (e.g., mobile telephone). Additionally, the display 507 and display circuitry are configured to facilitate user control of at least some functions of the mobile terminal. An audio function circuitry 509 includes a microphone 511 and microphone amplifier that amplifies the speech signal output from the microphone 511. The amplified speech signal output from the microphone 511 may be fed to a coder/decoder (CODEC) 513.

A radio section 515 amplifies power and converts frequency in order to communicate with a base station, which may be included in a mobile communication system, via antenna 517. The power amplifier (PA) 519 and the transmitter/modulation circuitry are operationally responsive to the MCU 503, with an output from the PA 519 coupled to the duplexer 521 or circulator or antenna switch, as known in the art. The PA 519 also couples to a battery interface and power control unit 520.

In use, a user of mobile terminal 501 speaks into the microphone 511 and his or her voice along with any detected background noise may be converted into an analog voltage. The analog voltage may be then converted into a digital signal through the Analog to Digital Converter (ADC) 523. The control unit 503 routes the digital signal into the DSP 505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 525 for compensation of any frequency-dependent impairments that occur during transmission though the air such as phase and amplitude distortion. After equalizing the bit stream, the modulator 527 combines the signal with a RF signal generated in the RF interface 529. The modulator 527 generates a sine wave by way of frequency or phase modulation. In order to prepare the signal for transmission, an up-converter 531 combines the sine wave output from the modulator 527 with another sine wave generated by a synthesizer 533 to achieve the desired frequency of transmission. The signal may be then sent through a PA 519 to increase the signal to an appropriate power level. In practical systems, the PA 519 acts as a variable gain amplifier whose gain may be controlled by the DSP 505 from information received from a network base station. The signal may be then filtered within the duplexer 521 and optionally sent to an antenna coupler 535 to match impedances to provide maximum power transfer. Finally, the signal may be transmitted via antenna 517 to a local base station. An automatic gain control (AGC) may be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 501 are received via antenna 517 and immediately amplified by a low noise amplifier (LNA) 537. A down-converter 539 lowers the carrier frequency while the demodulator 541 strips away the RF leaving only a digital bit stream. The signal then goes through the equalizer 525 and may be processed by the DSP 505. A Digital to Analog Converter (DAC) 543 converts the signal and the resulting output may be transmitted to the user through the speaker 545, all under control of a Main Control Unit (MCU) 503 which may be implemented as a Central Processing Unit (CPU) (not shown).

The MCU 503 receives various signals including input signals from the keyboard 547. The keyboard 547 and/or the MCU 503 in combination with other user input components (e.g., the microphone 511) comprise a user interface circuitry for managing user input. The MCU 503 runs a user interface software to facilitate user control of at least some functions of the mobile terminal 501 as described herein. The MCU 503 also delivers a display command and a switch command to the display 507 and to the speech output switching controller, respectively. Further, the MCU 503 exchanges information with the DSP 505 and may access an optionally incorporated SIM card 549 and a memory 551. In addition, the MCU 503 executes various control functions required of the terminal. The DSP 505 may, depending upon the implementation, perform any of a variety of conventional digital processing functions on the voice signals. Additionally, DSP 505 determines the background noise level of the local environment from the signals detected by microphone 511 and sets the gain of microphone 511 to a level selected to compensate for the natural tendency of the user of the mobile terminal 501.

The CODEC 513 includes the ADC 523 and DAC 543. The memory 551 stores various data including call incoming tone data and may be capable of storing other data including music data received via, e.g., the global Internet. The software module could reside in RAM memory, flash memory, registers, or any other form of writable storage medium known in the art. The memory device 551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 549 carries, for instance, important information, such as the cellular phone number, the carrier supplying service, subscription details, and security information. The SIM card 549 serves primarily to identify the mobile terminal 501 on a radio network. The card 549 also contains a memory for storing a personal telephone number registry, text messages, and user specific mobile terminal settings.

In some embodiments, the mobile terminal 501 includes a digital camera comprising an array of optical detectors, such as charge coupled device (CCD) array 565. The output of the array may be image data that may be transferred to the MCU for further processing or storage in the memory 551 or both. In the illustrated embodiment, the light impinges on the optical array through a lens 563, such as a pin-hole lens or a material lens made of an optical grade glass or plastic material. In the illustrated embodiment, the mobile terminal 501 includes a light source 561, such as a LED to illuminate a subject for capture by the optical array, e.g., CCD 565. The light source may be powered by the battery interface and power control module 520 and controlled by the MCU 503 based on instructions stored or loaded into the MCU 503.

### Aspects

The disclosure herein may feature one or more aspects , such as but not limited to:
A. A delivery management method, the method comprising: providing a user interface for communicating one or more consumer product subscriptions; receiving, from the user interface, an input indicating the consumer product subscription; outputting, on the user interface, an output indicating a consumer product for the consumer product subscription, a cost of the consumer product subscription and a quantity of the consumer products in a first shipment of the consumer product subscription; communicating information related to the first shipment of the consumer product subscription to a dispatching entity to dispatch the first shipment of the consumer product subscription; receiving a request for a second shipment of the consumer products in the consumer product subscription; comparing, with a processor, at least one of: a time period between at least one of the received input or the dispatch of the first shipment of the consumer product subscription and the received request for the second shipment of the consumer product subscription with a predetermined time period; or a time of the received request with a subscription time period; communicating at least one of: information to the dispatching entity to dispatch the second shipment of the consumer product subscription if the time period is greater than or equal to the predetermined time period; and information to indicate a rejection of the request for the second shipment of the consumer product subscription if the time period is less than the predetermined time period or if the time of the received request is after expiration of the subscription time period.
B. The method of paragraph A, wherein the consumer product subscription comprises a maximum total number of consumer products over the subscription time period.
C. The method of any of paragraphs A or B, further comprising automatically determining, with the processor, the quantity of the consumer products in the first shipment.
D. The method of any of paragraphs A through C, wherein the input received from the user interface further indicates a consumer product for the consumer product subscription.
E. The method of any of paragraphs A through D, wherein the consumer product is a razor cartridge.
F. The method of any of paragraphs A through E, wherein the providing the user interface comprises outputting, on a display, the user interface, wherein the display is a display on one of a mobile device, PC, smartphone or tablet.
G. The method of any of paragraphs A through F, wherein the receiving the input from the user interface further comprises receiving at least one of: a first quantity of the consumer products in each shipment of the consumer product subscription; or a second quantity indicating a maximum quantity of the consumer products for the consumer product subscription.
H. The method of any of paragraphs A through G, wherein the providing step comprises providing the user interface for communicating an array of subscriptions for the consumer product; and wherein the received input further indicates one of the array of consumer product subscriptions for the consumer product.
I. The method of any of paragraphs A through H, wherein the providing step comprises providing the user interfaces for communicating an array of consumer products for the consumer product subscription; and wherein the received input further indicates one of the array of consumer products for the consumer product subscription.
J. The method of any of paragraphs A through I, wherein the receiving the request for the second shipment comprises receiving an input from the user interface, said input indicating the request for the second shipment.
K. The method of any of paragraphs A through J, wherein the communicating the information to indicate the rejection comprises outputting, on the user interface, an indication that the second shipment request was denied.
L. The method of any of paragraphs A through K, wherein the received input further indicates payment information for the cost of the consumer product subscription.
M. The method of any of paragraphs A through L, wherein the received input further indicates selection of an option of a handle to be shipped with the first shipment of the razor cartridges.
N. The method of any of paragraphs A through M, further comprising scheduling the communicating of the information to the dispatching entity to dispatch the second shipment of the consumer product subscription at a second time period after the dispatch of the first shipment if the time period is less than the predetermined time period, wherein the second time period is greater than or equal to the predetermined time period.
O. The method of any of paragraphs A through N, further comprising communicating a notification to submit a third shipment request after a second time period following the dispatch of the first shipment if the time period is less than the predetermined time period, wherein the second time period is greater than or equal to the predetermined time period.
P. The method of any of paragraphs A through O, wherein the quantity of the consumer products in each of the first shipment and the second shipment is a first predetermined threshold quantity.
Q. The method of any of paragraphs A through P, wherein the consumer product is one or more of a razor cartridge, a toothbrush, a diaper and a paper towel.
R. The method of any of paragraphs A through Q, wherein the consumer product is a razor cartridge and wherein the first predetermined threshold quantity of the shaving cartridges is between 2 and 6 units.
S. The method of any of paragraphs A through R, wherein the communicating the information to indicate the rejection for the second shipment is further based on a total number of the consumer products in the first and second shipment exceeding a second predetermined threshold quantity of the consumer products in the consumer product subscription.
T. The method of any of paragraphs A through S, wherein the consumer product is a razor cartridge and wherein the second predetermined threshold quantity of the shaving cartridges in the shaving cartridge subscription is between 12 and 32 units.
U. The method of any of paragraphs A through T, wherein the received input from the user interface further indicates at least one of a first predetermined quantity of consumer products in each shipment of the consumer product subscription and a second predetermined quantity of consumer products for the consumer product subscription; and wherein the output on the user interface further indicates at least one of the first predetermined quantity of the consumer products in each shipment of the consumer product subscription and the second predetermined quantity of the consumer products for the consumer product subscription.
V. The method of any of paragraphs A through U, wherein the consumer product is a razor cartridge; wherein the first predetermined threshold quantity of the shaving cartridges is between 2 and 6 units; and wherein the second predetermined threshold quantity of the shaving cartridges in the shaving cartridge subscription is between 12 and 32 units.
W. The method of any of paragraphs A through V, further comprising communicating a reminder to submit the request for the second shipment between the dispatch of the first shipment and the receiving the request for the second shipment.
X. The method of any of paragraphs A through W, wherein the reminder is sent at a reminder time period after the dispatch of the first shipment, wherein the reminder time period is from 1 to 4 months.
Y. The method of any of paragraphs A through X, wherein the comparing step further comprises comparing, with the processor, a total number of requests received for shipments of the consumer products after the first shipment with a maximum total number of requests over the subscription time period; and wherein the communicating of the information to indicate the rejection is further based on the total number of requests exceeding the maximum total number of requests.
Z. The method of any of paragraphs A through Y, wherein the maximum total number of requests is between 4 and 10 and wherein the subscription time period is 1 year.

AA. A delivery management method, the method comprising:

receiving, from a user interface, an input indicating payment information for a cost of a shaving cartridge subscription comprising a maximum number of shaving cartridges;

outputting, on the user interface, an output indicating a shaving cartridge for the shaving cartridge subscription, the cost of the shaving cartridge subscription and the maximum number of shaving cartridges;

communicating information related to a first shipment of the shaving cartridge subscription to a dispatching entity to dispatch the first shipment of the shaving cartridge subscription, wherein the first shipment is between 2 and 6 shaving cartridges;

receiving a request for a second shipment of the shaving cartridges in the shaving cartridge subscription after receiving the first shipment of the shaving cartridge subscription;

comparing, with a processor, at least one of:

a time period between at least one of the received input or the dispatch of the first shipment of the shaving cartridge subscription and the received request for the second shipment of the shaving cartridge subscription with four weeks; or

a time of the received request for the second request with a subscription time period;

communicating at least one of:;

information to the dispatching entity to dispatch the second shipment of the shaving cartridge subscription if the time period is greater than four weeks, wherein the second shipment is between 2 and 6 shaving cartridges, and

information to indicate a rejection of the request for the second shipment of the shaving cartridge subscription if the time period is less than four weeks or if the time of the received request is after expiration of the subscription time period.

AB. A computer-implemented process for efficiently delivering orders of products to a consumer, the process comprising:

providing a user interface for communicating a consumer product subscription;

receiving, from the user interface, an input indicating a consumer product for the consumer product subscription;

outputting, on the user interface, an output indicating the consumer product for the consumer product subscription, a cost of the consumer product subscription and a quantity of the consumer products in a first shipment of the consumer product subscription;

communicating information related to the first shipment of the consumer product subscription to a dispatching entity to dispatch the first shipment of the consumer product subscription;

receiving a request for a second shipment of the consumer products in the consumer product subscription;

comparing, with a processor, a time period between the dispatch of the first shipment of the consumer product subscription and the received request for the second shipment of the consumer product subscription with a predetermined time period; and

communicating at least one of;

information to the dispatching entity to dispatch the second shipment of the consumer product subscription if the time period is greater than or equal to the predetermined time period, and

information to indicate a rejection of the request for the second shipment of the consumer product subscription if the time period is less than the predetermined time period.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A delivery management method, the method comprising:
providing a user interface for communicating one or more consumer product subscriptions;
receiving, from the user interface, an input indicating the consumer product subscription;
outputting, on the user interface, an output indicating a consumer product for the consumer product subscription, a cost of the consumer product subscription and a quantity of the consumer products in a first shipment of the consumer product subscription;
communicating information related to the first shipment of the consumer product subscription to a dispatching entity to dispatch the first shipment of the consumer product subscription;
receiving a request for a second shipment of the consumer products in the consumer product subscription;
comparing, with a processor, at least one of:
a time period between at least one of the received input or the dispatch of the first shipment of the consumer product subscription and the received request for the second shipment of the consumer product subscription with a predetermined time period; or
a time of the received request with a subscription time period;
communicating at least one of:
information to the dispatching entity to dispatch the second shipment of the consumer product subscription if the time period is greater than or equal to the predetermined time period; and
information to indicate a rejection of the request for the second shipment of the consumer product subscription if the time period is less than the predetermined time period or if the time of the received request is after expiration of the subscription time period.

2. The method of claim 1, wherein the consumer product subscription comprises a maximum total number of consumer products over the subscription time period.

3. The method of claim 1, further comprising automatically determining, with the processor, the quantity of the consumer products in the first shipment.

4. The method of claim 1, wherein the input received from the user interface further indicates a consumer product for the consumer product subscription.

5. The method of claim 1, wherein the consumer product comprises one or more of a razor cartridge, a toothbrush, a diaper and a paper towel.

6. The method of claim 1, wherein the quantity of the consumer products in each of the first shipment and the second shipment is a first predetermined threshold quantity.

7. The method of claim 6, wherein the consumer product is a razor cartridge and wherein the first predetermined threshold quantity of the shaving cartridges is between 2 and 6 units.

8. The method of claim 1, wherein the receiving the input from the user interface further comprises receiving at least one of:
a first quantity of the consumer products in each shipment of the consumer product subscription; or
a second quantity indicating a maximum quantity of the consumer products for the consumer product subscription.

9. The method of claim 1, wherein the receiving the request for the second shipment comprises receiving an input from the user interface, said input indicating the request for the second shipment.

10. The method of claim 1, wherein the communicating the information to indicate the rejection comprises outputting, on the user interface, an indication that the second shipment request was denied.

11. The method of claim 1, wherein the received input further indicates payment information for the cost of the consumer product subscription.

12. The method of claim 5, wherein the received input further indicates selection of an option of a handle to be shipped with the first shipment of the razor cartridges.

13. The method of claim 1, further comprising communicating a notification to submit a third shipment request after a second time period following the dispatch of the first shipment if the time period is less than the predetermined time period, wherein the second time period is greater than or equal to the predetermined time period.

14. The method of claim 1, wherein the communicating the information to indicate the rejection for the second shipment is further based on a total number of the consumer products in the first and second shipment exceeding a second predetermined threshold quantity of the consumer products in the consumer product subscription.

15. The method of claim 14, wherein the consumer product is a razor cartridge and wherein the second predetermined threshold quantity of the shaving cartridges in the shaving cartridge subscription is between 12 and 32 units.

16. The method of claim 1,
wherein the received input from the user interface further indicates at least one of a first predetermined quantity of consumer products in each shipment of the consumer product subscription and a second predetermined quantity of consumer products for the consumer product subscription; and
wherein the output on the user interface further indicates at least one of the first predetermined quantity of the consumer products in each shipment of the consumer product subscription and the second predetermined quantity of the consumer products for the consumer product subscription.

17. The method of claim 16, wherein the consumer product is a razor cartridge;
wherein the first predetermined threshold quantity of the shaving cartridges is between 2 and 6 units; and
wherein the second predetermined threshold quantity of the shaving cartridges in the shaving cartridge subscription is between 12 and 32 units.

18. The method of claim 1, further comprising communicating a reminder to submit the request for the second shipment between the dispatch of the first shipment and the receiving the request for the second shipment.

19. The method of claim 18, wherein the reminder is sent at a reminder time period after the dispatch of the first shipment, wherein the reminder time period is from 1 to 4 months.

20. A computer-implemented process for efficiently delivering orders of products to a consumer, the process comprising:
providing a user interface for communicating a consumer product subscription;
receiving, from the user interface, an input indicating a consumer product for the consumer product subscription;
outputting, on the user interface, an output indicating the consumer product for the consumer product subscription, a cost of the consumer product subscription and a quantity of the consumer products in a first shipment of the consumer product subscription;
communicating information related to the first shipment of the consumer product subscription to a dispatching entity to dispatch the first shipment of the consumer product subscription;
receiving a request for a second shipment of the consumer products in the consumer product subscription;
comparing, with a processor, a time period between the dispatch of the first shipment of the consumer product subscription and the received request for the second shipment of the consumer product subscription with a predetermined time period; and
communicating at least one of;
information to the dispatching entity to dispatch the second shipment of the consumer product subscription if the time period is greater than or equal to the predetermined time period, and
information to indicate a rejection of the request for the second shipment of the consumer product subscription if the time period is less than the predetermined time period.
